(19) United States
(12) Patent Application Publication
(10) Pub. No.: US 2008/0103747 A1
(43) Pub. Date: May 1, 2008

(54) MODEL PREDICTIVE CONTROL OF A STILLAGE SUB-PROCESS IN A BIOFUEL PRODUCTION PROCESS

(76) Inventors: Maina A. Macharia, Round Rock, TX (US); Michael E. Tay, Georgetown, TX (US)

Correspondence Address: Jeffrey C. Hood;Meyertons Hood Kivlin Kowert & Goetzel PC, P.O. Box 398, Austin, TX, 78767-0398, US

(21) Appl. No.: 11/924,370

(22) Filed: Oct. 25, 2007

Related U.S. Application Data
(60) Provisional application No. 60/863,759, filed on Oct. 31, 2006.

(51) Int. Cl. G06G 7/58

(52) U.S. Cl. 703/11

(57) ABSTRACT

System and method for managing a biofuel stillage sub-process of a biofuel production process using a dynamic multivariate predictive model of the stillage sub-process. An objective for the stillage sub-process is received specifying target production of output of the stillage sub-process, including a target value for moisture content of one or more of: dry distillers grain, wet distillers grain, or evaporator syrup. Process information comprising stillage sub-process information is received from the biofuel production process. The dynamic multivariate predictive model is executed in accordance with the objective using the process information as input, to generate model output comprising target values for a plurality of manipulated variables related to the stillage sub-process, in accordance with the objective. The biofuel production process is controlled in accordance with the target values of the plurality of manipulated variables to control production of outputs or inputs of the stillage sub-process in accordance with the objective.

### PRIORITY DATA

This application claims benefit of priority of U.S. provisional application Ser. No. 60/863,759 titled “Model Predictive Control of a Biofuel Production Process” filed Oct. 31, 2006, whose inventors were Michael E. Tay, Maina A. Macharia, Celso Axelrud, and James Bartee.

### FIELD OF THE INVENTION

The present invention generally relates to the field of model predictive control of production processes for biofuel and its co-products. More particularly, the present invention relates to systems and methods for model predictive control of a stillage sub-process in a biofuel production process.

### DESCRIPTION OF THE RELATED ART

### History of Biofuel

Biofuel refers to any fuel derived from biomass, i.e., from recently living organisms or their bi-products. Biofuels were used in automobiles from approximately 1876-1908. The Otto Cycle (1876) was the first combustion engine designed to use alcohol and gasoline. Henry Ford's Model T (1908) was designed to use biofuel, gasoline, or any combination of the two fuels. However, high government tariffs on alcohol discouraged the use of biofuel, and gasoline became the predominant fuel choice for automobiles for many decades.

The energy crisis of the 1970s renewed the search for an alternative to fossil fuels. The Energy Tax Act of 1978 (H. R. 5263) provided a 4 cents per gallon exemption from Federal excise taxes to motor fuels blended with biofuel (minimum 10 percent biofuel) and granted a 10% energy investment tax credit for biomass-biofuel conversion equipment (in addition to the 10% investment tax credit available) that encouraged plant building. However, by 1985, only 45% of the 163 existing commercial biofuel plants were operational. This high plant failure rate was partially the result of poor business judgment and inefficient engineering design. In 1988, biofuel was used as an oxygenate in Denver, Colo., which mandated the use of oxygenated fuels during winter use. Oxygenated fuels are fuels that have been infused with oxygen to reduce carbon monoxide emissions and NOx emissions created during the burning of the fuel. The Clean Air Act in the 1990s, motivated an additional increase in the use of biofuel as a pollution control additive.

The US Congress passed the Clean Air Act Amendments of 1990, which mandated the use of “reformulated gasoline” containing oxygenates in high-pollution areas. Starting in 1992, Methyl Tertiary Butyl Ether (MTBE) was added to gasoline in higher concentrations in accordance with the Clean Air Act Amendments. Improvements in air quality in many areas has been attributed to the use of gas reformulated with MBTE. However by 2000, MTBE—(a known carcinogenic agent) was found to have contaminated groundwater systems, mostly through leaks in underground gasoline storage tanks. In 2004, Cailifornia and New York banned MTBE, generally replacing it with ethanol. Several other states started switching soon afterward. The 2005 Energy Bill required a phase out of MTBE and did not provide legal protection for the oil companies. As a result, the oil companies began to replace MTBE with ethanol (one embodiment of a biofuel), thereby spurring growth in the biofuels industry.

Since 2001, there has been a steady rise in crude oil prices that has increased the price of gasoline above the break-even point of biofuel's cost of production. This has been very beneficial to Mid-west agricultural regions that have always sought ways to diversify demand for agricultural goods and services. Biofuel plants that had depended on subsidies to be profitable are now transitioning to an economically viable venture for this corn-rich region.

### Biofuel Production Plants

An exemplary high-level design of a biofuel production plant or process is shown in FIG. 1, which illustrates how biomass is processed through several stages to produce biofuel and one or more co-products. Biomass is first provided to a milling and cooking process, e.g., milling and cooking units 104, where water 102 (and possibly recycled water RW1 and RW2) is added and the biomass is broken down to increase the surface area to volume ratio. This increase in surface area allows for sufficient interaction of the water and biomass surface area to achieve a solution of fermentable sugars in water. The mixture, a biomass and water slurry, is cooked to promote an increase in the amount of contact between the biomass and water in solution and to increase the separation of carbohydrate biomass from the non-carbohydrate biomass. The output of the milling and cooking units 104 (i.e., the fermentation feed or mash) is then sent to a fermentation process, where one or more fermentation units 106 operate to ferment the biomass/water mash produced by the milling and cooking process.

As FIG. 1 indicates, the fermentation process may require additional water 102 to control the consistency of material to the fermentation units (also referred to herein as a fermenter). Biomass is converted by yeast and enzymes into a biofuel and by-products such as carbon dioxide, water and non-fermentable biomass (solids), in the fermentation units 106.

The output from the fermentation units 106 is sent to a distillation process, e.g., one or more distillation units 108, to separate biofuel from water, carbon dioxide, and non-fermentable solids. If the biofuel has to be dehydrated to moisture levels less than 5% by volume, the biofuel can be processed through a processing unit called a molecular sieve or similar processing units (including, for example, additive distillation such as cyclohexane that breaks a water/ethanol azeotrope). The finalized biofuel is then processed to ensure it is denatured and not used for human-consumption.

The distillation units 108 separate the biofuel from water. Water 102 is used in the form of steam for heat and separation, and the condensed water is recycled (RW1) back to the milling and cooking units 104, as shown in FIG. 1. Stillage (non-fermentable solids and yeast residue), the heaviest output of the distillation units, is sent to stillage processing for further development of co-products from the biofuel production process.

Stillage processing units 110 separate additional water from the cake solids and recycle this water (RW2) back to the milling and cooking units 104. There are a number of stillage processing options: stillage can be sold with minimal processing, or further processed by separating moisture from the solids product via one or more centrifuge units. From the centrifuge, the non-fermentable solids may be transported to dryers for further moisture removal. A portion of the stillage liquid (centrate) may be recycled back to the fermentation units 106; however, the bulk of the flow is generally sent to evaporator units, where more liquid is separated form the liquid stream, causing the liquid stream to concentrate into syrup, while solid stillage is sent to a drying process, e.g., using a drying unit or evaporator, to dry the solid stillage to a specified water content. The syrup is then sent to the syrup tank. Syrup in inventory can be processed/utilized with a number of options: it can be sprayed in dryers to achieve a specified color or moisture content; it can be added to the partially dried stillage product, or it can be is sold as a separate liquid product. The evaporator unit may have a water by-product stream that is recycled back to the front end (RW2), e.g., to the milling and cooking units 104.

Note that an energy center 112 supplies energy to various of the processing units, e.g., the milling and cooking units 104, the distillation 108 and mole-sieve units, and the stillage processing units. The energy center 112 may constitute a thermal oxidizer unit and heat recovery steam generator that destroys volatile organic compounds (VOCs) and provides steam to the evaporators, distillation units 108, cooking system units (e.g., in 104), and dehydration units. The energy center 112 is typically the largest source of heat in the biofuels plant

In prior art biofuel plants, properties such as temperature or product quality are controlled with control systems utilizing traditional control schemes such as temperature, pressure, level, and/or flow control schemes, which may include proportional integral derivative (PID), cascade, feedfoward, and/or constraint control schemes, among others.

Systems can be open or closed. An open loop system is a system that responds to an input, but the system is not modified because of the behavior of the output. FIG. 2 illustrates a generic open loop process/system 202, where the process/system 202 receives process input, and generates process output, with no feedback from output back to input. Open loop systems are only defined by the inputs and the inherent characteristics of the system or process. In the biofuel production process, the system may comprise the entire bio-processing plant, one process section of the bio-processing plant, such as the milling and cooking units, or a controller for a variable in a process such as the temperature of the cooking units.

In a closed loop system, the inputs are adjusted to compensate for changes in the output, where, for example, these changes may be a deviation from the desired or targeted measurements. The closed loop system senses the change and provides a feedback signal to the process input. FIG. 3 illustrates a generic closed loop process/system where the process/system 202 receives process input and generates process output, but where at least a portion of the output is provided back to the input as feedback. Process units in the biofuel system may be closed loop systems if they need to be regulated subject to constraints such as product quality, energy costs, or process unit capacity.

Modern plants apply traditional and advanced controls to regulate complex processes to achieve a specific control objective. Traditional PID controllers and other control systems such as ratio controls, feed-forward controls, and process models may be used to control biofuel production processes (a PID is a control algorithm or device that uses three basic feedback control modes to act on a deviation from its control objective: proportional action control (P), integral action (I), and derivative (D) rate of change action). A DCS (distributed control system) will have many traditional control schemes set up to control the process unit variables at the local control level.

Most biofuel production facilities mill or steep corn, other grains, or other biomass (e.g. sugarcane), and mix this milled carbohydrate base with water from a variety of sources and quality.

The operating challenge is to provide a steady quality and concentration of feed to the fermentation units. However, due to variability in feed amount, flow rates, mill rates, steep efficiencies, or biomass (e.g., grain) quality, the fermentation output varies dramatically and the process operates sub-optimally due to this large variability. Fermentation end concentrations of biofuel may vary plus or minus 10% or more.

Plants are currently implemented to provide some information to plant operators to enable them to increase or decrease the feed of fermentable sugar and starch concentrations to fermentation tanks. Plant operators monitor the target feed quality and percent solids in the fermentation feed and run the plants to achieve a target percent solids so that each fermentation batch is started with a rough approximation of the target percent solids and each fermentation process runs over a specific time period in an attempt to achieve an output with approximately the design target percent of biofuel. In addition, a recycle flow rate is typically managed to maintain tank inventory levels within safe operating limits, while providing sufficient water/liquid to mix with grain or other biomass solids to fill a fermentation tank within a targeted time period (i.e. fill a vessel of 180,000 gallons in 15 hours so that the fill rate would be 600 gallons per minute).

In addition, levels of various water sources tend to increase or decrease, and operators or level controllers may adjust flows to regain targeted levels. In general, these applications are controlled with flow, level or mill speed controllers (e.g., regulatory level controllers). Some applications of ratio controllers are used in current control systems (e.g., to monitor the ratio of enzyme flow rates to grain slurry flow rates).

Two additional calculated parameters are also important to plant operators. The first parameter is Percent Recycle (also referred to as backset), which is the fractional percentage of recycled thin stillage (fermentation liquor output from a centrifuge that separates out cattle feed solids). Percent Recycle is managed manually to maintain both a rough thin stillage inventory and to operate within a range of fractional percent backset. It is important to manage the fractional percent backset, because the fermentation liquor contains both residual yeast nutrients along with yeast waste products from previous fermentation. Too little or too much backset can be a problem for fermentation productivity.

The second parameter is Fermentation Inventory, which is a totalized inventory across the filling, draining and fermenting fermentation vessels and key auxiliary equipment. If this total inventory level is held within an acceptably stable band, the front plant section, i.e., the milling/cooking, and fermentation processes, can be managed to match the back plant section, i.e., the distillation and stillage processes, across all batch sequentially operated fermentation vessels. If totalized batch volume is constant, then filling is balanced with draining across multiple parallel batch fermentation vessels.

A biofuel production plant may require numerous adjustments, e.g., on a minute-to-minute basis, in response to changes and shifting constraints if the plant process is to operate in an optimal manner. Due to this complexity, human operators are not capable of actively optimizing a biofuel production process. Consequently, operators generally operate a plant in a less efficient operating mode.

Thus, improved systems and methods for biofuel production are desired.

### SUMMARY OF THE INVENTION

Embodiments of a system and method are presented for managing a stillage sub-process in a biofuel production process. In one embodiment, the system may include a dynamic multivariate predictive model-based controller coupled to a memory medium storing a dynamic multivariate predictive model of the stillage sub-process of the biofuel production process.

The dynamic multivariate predictive model-based controller may be operable to: receive process information from the biofuel production process; receive an objective for the stillage sub-process specifying at least one measurable attribute defining output quantity, quality, or composition for the stillage sub-process; and execute the dynamic multivariate predictive model to generate model output comprising target values for a plurality of manipulated variables related to the stillage sub-process in accordance with the specified objective. In some embodiments, the target values may include or be one or more trajectories of values over a time horizon, e.g., over a prediction or control horizon.

The dynamic multivariate predictive model-based controller may be operable to dynamically control the biofuel production process by communicating target values for the plurality of manipulated variables to a distributed process control system that may adjust the manipulated variables to achieve the target values within a determined time horizon. The distributed process control system may then communicate the new values for the manipulated variables and control variables to the dynamic multivariate predictive model-based controller, and the process may be repeated as appropriate to achieve the desired control of the biofuel production process.

In one embodiment, the method may include providing a dynamic multivariate predictive model of the stillage sub-process of the biofuel production process; receiving an objective for the stillage sub-process specifying target production of one or more outputs of the stillage sub-process (which may include one or more of: a target composition of the output products of the stillage sub-process, production rates of the one or more output products of the stillage sub-process, or a target feed rate of the stillage sub-process (i.e., input stillage feed rate from one or more distillation units)). In some embodiments, the objective may specify target values for one or more of: dry distillers grain moisture content, wet distillers grain moisture content, or evaporator syrup moisture content. Process information, including stillage sub-process information, may be received from the biofuel production process, and the dynamic multivariate predictive model may be executed in accordance with the objective using the received process information as input, to generate model output including target values for a plurality of manipulated variables related to the stillage sub-process, in accordance with the objective. The biofuel production process may then be controlled in accordance with the target values of the plurality of manipulated variables to control production of the one or more outputs or inputs of the stillage sub-process in accordance with the objective.

In one embodiment, the objective includes one or more sub-objectives. For example, the objective may be or include an objective function, where the objective function specifies a set of objective values corresponding to each of the one or more sub-objectives. In some embodiments, each of the objective values may be a value type selected from a set of value types including: minimum value, maximum value, greater than a specified value, less than a specified value, and equal to a specified value. Moreover, in some embodiments, the objective function includes a combination of two or more value types.

In some embodiments, the dynamic multivariate predictive model may include one or more of: a linear model, a nonlinear model, a fundamental model, an empirical model, a neural network, a support vector machine, a statistical model, a rule-based model, or a fitted model. For example, in some embodiments where a hybrid approach is used, the dynamic multivariate predictive model may include a fundamental model (e.g., a model based on chemical and/or physical equations) plus one or more of: a linear empirical model, a nonlinear empirical model, a neural network, a support vector machine, a statistical model, a rule-based model, or an otherwise empirically fitted model.

In some embodiments, the execution of the dynamic multivariate predictive model may include executing the model in an iterative manner, e.g., via an optimizer, e.g., a nonlinear optimizer, varying manipulated variable values (which are a subset of the model inputs) and assessing the resulting model outputs according to the objective, to determine target values of the manipulated variables that satisfy the objective over a determined time horizon.

In some embodiments, the objective for the stillage sub-process may be specified by a human operator and/or by a program, i.e., programmatically.

In some embodiments, the method may further include: receiving constraint information specifying one or more constraints, e.g., process constraints, equipment constraints, regulatory constraints, and/or economic constraints, among others, and executing the dynamic multivariate predictive model in accordance with the objective using the received process information and the one or more constraints as input, to generate model output in accordance with the objective and subject to the one or more constraints.

In some embodiments, the dynamic multivariate predictive model may specify relationships between stillage sub-process output composition and equipment constraints of the biofuel production process, the dynamic multivariate predictive model-based controller may receive the one or more equipment constraints as input, and the target values for the manipulated variables may be computed to approach and maintain the target output composition subject to the one or more equipment constraints. For example, in one embodiment, controlling the biofuel production process may include controlling a stillage feed flow rate, including operating stillage feed flow controllers based on target production of one or more outputs of the stillage sub-process.

In some embodiments, the stillage sub-process includes two or more of: a first stage distillation process, a stillage separation process, or a stillage evaporation process of a biofuel production process. The plurality of manipulated variables may include one or more of: energy use for the first stage distillation process, stillage separation process, and/or stillage evaporation process, in accordance with the objective, or throughput for the first stage distillation process, stillage separation process, and/or stillage evaporation process, in accordance with the objective.

In one embodiment, the dynamic multivariate predictive model may represent relationships between a distillation downstream dehydration process and evaporator heat recovery, and the process information may include throughput in the downstream dehydration process, and/or energy use in the downstream dehydration process.

In another embodiment, the dynamic multivariate predictive model may represent relationships between energy use of a stillage dryer process and energy input to an thermal oxidizer that oxidizes exhaust from the stillage dryer process, and the process information may include one or more of: dryer energy consumption, or dryer temperature. The plurality of manipulated variables may further include energy input to the thermal oxidizer.

In a further embodiment, the dynamic multivariate predictive model may represent relationships between energy use of centrifuges of the stillage separation process, energy use of a stillage evaporator, and wet distillers grain moisture content and/or syrup moisture content. The process information may include one or more of: centrifuge energy consumption, centrifuge throughput, evaporator energy consumption, evaporator throughput, or ratio of wetcake and evaporator syrup to wet distillers grain product. The plurality of manipulated variables may further include one or more of: the centrifuge energy consumption, the centrifuge throughput, the evaporator energy consumption, the evaporator throughput, or the ratio of wetcake and evaporator syrup to wet distillers grain product.

Moreover, in preferred embodiments, the method may also include repeating the above receiving an objective, receiving process information, executing the dynamic multivariate predictive model, and controlling the biofuel production process with a specified frequency, utilizing updated process information and objectives in each repetition the frequency may be programmable, and/or operator-determined, as desired. For example, in one embodiment, the frequency may be determined by changes in process, equipment, regulatory, and/or economic constraints, among other factors.

Additionally, in some embodiment, receiving the process information may include receiving information from one or more inferential models of parameters for the stillage sub-process.

### BRIEF DESCRIPTION OF THE DRAWINGS

A better understanding of the present invention can be obtained when the following detailed description of the preferred embodiment is considered in conjunction with the following drawings, in which:

FIG. 1 illustrates one example of a biofuel processing plant, according to the prior art;

FIG. 2 illustrates an open loop process system, according to the prior art;

FIG. 3 illustrates a closed loop process system, according to the prior art;

FIG. 4 illustrates an exemplary high-level processing flow schematic of plant sections of a biofuel processing plant, according to one embodiment;

FIG. 5 is a high-level flowchart of a method for managing a sub-process of a biofuel production process utilizing model predictive control, according to one embodiment;

FIG. 6 illustrates a simplified view of an automated control system for a biofuel production plant, according to one embodiment;

FIG. 7A is a high-level block diagram of a system for managing a sub-process of a biofuel production process utilizing model predictive control, according to one embodiment;

FIG. 7B is a high-level block diagram of a system for managing a stillage sub-process of a biofuel production process utilizing model predictive control, according to one embodiment; and

FIG. 8 is a high-level flowchart of a method for managing a stillage sub-process of a biofuel production process utilizing model predictive control, according to one embodiment.

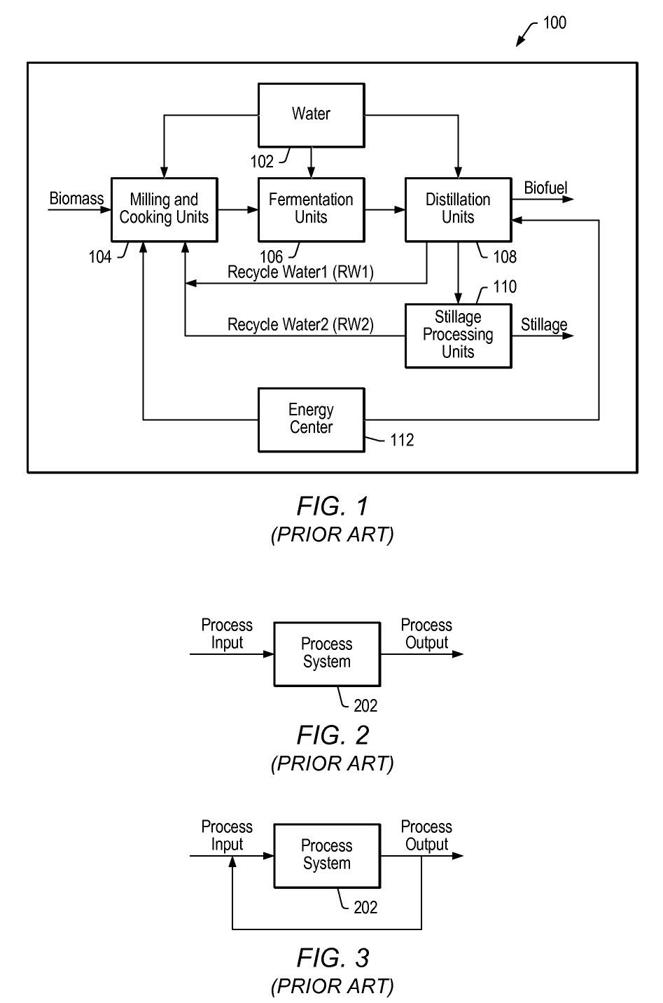

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION OF THE INVENTION

### INCORPORATION BY REFERENCE

The following references are hereby incorporated by reference in their entirety as though fully and completely set forth herein:

U.S. provisional application Ser. No. 60/863,759 titled “Model Predictive Control of a Biofuel Production Process” filed Oct. 31, 2006, whose inventors were Michael E. Tay, Maina A. Macharia, Celso Axelrud, and James Bartee.

### DEFINITIONS—BIOFUEL PRODUCTION PROCESSES

Biofuel—any fuel (or fuels) derived from biomass, i.e., from recently living organisms or their bi-products.

Biofuel production process—a fermentation process surrounded by auxiliary processing units to produce biofuel, other fermentable alcohols for fuel, and high-capacity food grade or chemical grade alcohols.

Biofuel production—a measure of biofuel production within or at the end of a production process. May include measurements such as concentration (e.g., wt. %, volume % or wt./vol. %), volume (e.g., current gallons biofuel within a fermenter) or mass (e.g., current kg biofuel within a fermenter).

Batch processing—a staged discontinuous processing step that includes a start and an end, in contrast to continuous processing that continues without stop, e.g., during a normal operating day or week. Continuous processing is generally represented by fairly steady targets or operations, where at least some parameters change throughout batch processing. For example, biofuel production, e.g., fermentation, starts at low levels at the start of a batch and increases throughout the batch with or without a drop at the end representing degradation rates being higher than production rates. Similarly, yeast cellular concentrations, start at fairly low levels, and generally grow throughout a batch, although they generally have a lag (relatively constant concentrations), exponential growth, stable growth, and degradation phase within a batch.

Slurry—a fermentation feed mash comprising a two-phase (liquid and solid) slurry that will be fermented.

Solids or % solids—fraction or percent of solids in the fermentation feed.

Milling and Cooking Process—continuous processing for pre-fermentation of the fermentation feed, which generally includes grain or cane milling, cooking, mixing with water and processing chemicals, cooking for sterilization and increasing water concentration within solids, and other pre-fermentation processing.

Biomass concentration—content attribute of the fermentation feed specified by one or more of: slurry solids, liquefaction solids, slurry density, liquefaction density, slurry % or fraction carbohydrates, and slurry % or fraction fermentable sugar.

Liquids inventory information—includes water flows, recycle liquid flows, evaporator condensate recycle flow, thin stillage or centrifuge liquor recycle flows, water addition flows, processed water addition flows, slurry flows, mash flows, and various levels or weights for various tanks used to hold inventories of these flows or for intermediate receptacles (e.g. methanator feed tank, slurry feed tank, liquefaction tank, distillate tank, grain silo inventories or other biomass inventories (not water), etc.).

Liquefaction—for grains with high starch content, the starch is liquefied to reduce its carbohydrate chain length and viscosity by adding enzymes or other biologic agents.

Thermal Oxidizer/Heat Recovery Steam Generator (HRSG)—process equipment that is used to destroy volatile organic compounds (VOCs), to reduce air and remove stenches from stillage dryer or evaporation systems. The heat recovery steam generator is used to recover the heat required to destroy the VOCs, and is typically the energy center of the biofuels production process.

Dried Distillers Grains (DDG)—post fermentation solid residue that includes undigested grain residue, other solid residues (enzymes, salts), and yeasts (or other cellular residue) that may be dried and released as a production by-product (generally as animal feed). DDG may also be used herein to include WDG (wet distillers grains), which are only partially dried for local consumption (e.g. without long-term biological stability) and DDGS/WDGS (dried distillers grains with solubles and wet distillers grains with solubles). Solubles includes residue solids that are soluble in water and therefore present in stillage concentrate. Solubles may be partially concentrated (generally with evaporation), and added to DDG or WDG to increase yields and manage by-product inventories.

Enzyme—highly selective biological-based catalyst added to manage specific reactions within a fermentation process. The most common enzymes used today include alpha amylase to rapidly break starches into dextrins, gluco-amylase to break dextrins into glucose, and proteases to break grain proteins into digestible proteins to support cell growth. In the same way as described below, modeling and controlling starch-based fermentations, enzymes specific for cellulosic conversion into biofuels or other enzymes affecting yeast (see below), growth or nutrient availability may be managed.

Yeast—a biofuel producing organism. Yeasts are currently the most commonly used organism in ethanol production although other biofuel producing organisms including genetically engineered E. coli can be substituted throughout as the technology described may not be specific to yeast, and may apply to many organisms used in fermentation processes to produce biofuel.

Stillage/Whole Stillage—non-fermentable solids and water liquid removed from the bottom of the primary distillation units.

Thin Stillage—the separated liquid from the stillage non-fermentable solids.

Syrup—concentrated thin-stillage with a large portion of the moisture removed. The % solids in syrup are usually in the range of 20-45% solids, but percentages outside this range may occur.

Azeotrope—a special mixture of two compounds, that when in equilibrium, the vapor phase and liquid phase have exactly the same compositions. This makes it difficult to separate the two components to achieve a better purity. Special separation processes are required to break the azeotrop. They comprise azeotropic distillation (add a 3^{rd} compound to break the azeotrop), extractive distillation (use a solvent to separate the 2 compounds), or molecular sieve technology (preferentially trap molecules of one component in a molecular sieve bed as the other component passes over the molecular sieve bed).

Volatile Organic Compounds (VOCS)—Organic compounds that tend to vaporize when subject to atmospheric pressure and ambient temperature ranges.

Capacity—capacity is the established maximum production rate of the process, sub-process, or unit under best operating conditions (no abnormal constraints). Capacity is generally a constant within the present capital investment. For new units it is the vendor's specified capacity. For established units, capacity is established by demonstrated historical production rates.

Model—an input/output representation, which represents the relationships between changes in various model inputs and how the model inputs affect each of the model outputs.

Dynamic Predictive Model—an input/output representation of a system or process that not only reflects how much an output changes when an input is changed, but with what velocity and over what time-dependent curve an output will change based on one or more input variable changes. A dynamic multivariate predictive model is a dynamic predictive model that represents or encodes relationships among multiple parameters, and is operable to receive multiple inputs, and generate multiple outputs.

Model Predictive Control (or MPC)—use of multivariate dynamic process models to relate controller objectives (targeted controller outputs and constraints) with regulatory controllers (existing single-input/single-output controllers such as ratio flow, temperature, level, speed, or pressure controllers) over a predicted time interval (e.g., 1 minute, 30 minutes, 2 hours, 100 hours, etc.).

Objective Function—encodes an objective that sets the goal or goals for the overall operation of the process, sub-process, or unit. The objective function provides one or more consistent numerical metric(s) to which the process, sub-process, or unit strives to achieve and over which the performance of the process, sub-process, or unit may be measured, e.g., from a business.

Control Variables—(also called controlled variables) those variables that the controller/optimizer tries to bring to a specified value, e.g., to a target value, maximum, etc. The range of allowed values for each control variable may be limited by constraints.

Integrated Variables—integrated control variables are variables that are not stable, but integrate generally with a stable first derivative as a function of time. The most common integrated variable is a tank level where as long as inputs and outputs are imbalanced the level will increase or decrease. Thus, when balanced a change in an input or output flow will cause a tank to either overfill or drain as integrated over time. A controller must use these integration calculations to determine when and how rapidly input or output flows must be adjusted.

Manipulated Variables—those variables over which the management of the process or unit has authority and control, e.g., via regulation of the process with online controllers, and which are changed or manipulated by the controller/optimizer to achieve the targets or goals of the control variables. Manipulated variables may operate within some range of controllable or fixed constraints. Manage is an alternate term for process control.

Disturbance Variable—a variable representing an external influence on a process that, in addition to objective variables and regulatory controllers, is outside the controller scope, and so it acts on the objective variables, but independently of the described controller. Disturbance variables are used in feed-forward disturbance rejection. Disturbance variables are also measured or unmeasured variables over which the management of the process or unit does not have direct authority or control. For example, temperature, humidity, upstream flow, or quality, may all be referred to as measured disturbance variables.

Set Point (targets)—also “setpoint”; the target signal or value for a manipulated variable or targeted controlled variable.

Constraints—Constraints represent limitations on particular operating variables or conditions that affect the achievable production rate of a production unit. Constraints are of two types: controllable and external, defined below. Constraints may include, but are not limited to: safety constraints, equipment constraints, equipment availability constraints, personnel constraints, business execution constraints, control constraints, supply chain constraints, environmental permit and legal constraints. Safety constraints ensure the safety of equipment and personnel. Equipment constraints, such as the maximum open position of a control valve, maximum tank capacity, etc., may limit the physical throughput of the unit. Equipment availability constraints may include, but are not limited to: readiness due to maintenance planning and scheduling, or due to unexpected equipment outages, authorized production level set by the supply chain and production scheduling systems. Personnel constraints refer to limitations on the availability of staffing and support functions, business rules and constraints imposed by contract and policy. Business execution constraints are limits imposed by the time required to execute associated business and contractual tasks and obligations. Control constraints are limits on the maximal position and rate of change of manipulated variables. Supply chain constraints are limits on the availability of raw materials, energy, and production supplies. Environmental permit and legal constraints are limits on air emissions, wastewater, waste disposal systems, and/or environmental constraints imposed upon the performance of the unit, such as river levels and current weather imposed limitations.

Controllable Constraints—constraints imposed on the performance of a process or unit over which the management of the process or unit does have authority and discretionary control. For example, the separation in a distillation tower may be affected by distillation tray fouling. The tray fouling is a function of how the feedstock is processed, and how often the unit is taken offline for cleanup. It is management's discretion as to when the unit is serviced. Controllable constraints change a unit's throughput capacity.

External Constraints—limitations imposed on the performance of the process, sub-process, or unit over which the management of the process, sub-process, or unit does not have authority or discretionary control. These external constraints come in two types: external constraints that are controllable by other entities or processes in the plant or in the supply chain, and those constraints that are imposed by physical, safety, environmental, or legal constraints and are not controllable by anyone in the plant or supply chain.

System—a system may be defined by the inputs and the characteristics of the system or process. In the biofuel production process, the system may be defined for: the entire biofuel production process, a sub-process of the biofuel production process such as the milling and cooking process, or control of a variable in a sub-process such as the cooking temperature.

Open Loop Systems—are systems that respond to an input, but the system is not modified because of the behavior of the output (see FIG. 2). For example, in a biofuel system, a reciprocating pump will operate and move at a fixed volume of syrup independent of the upstream and downstream pressure if the reciprocating pump does not have a pressure control system.

Closed Loop Systems—system inputs may be adjusted to compensate for changes in the output. These changes may be a deviation from an objective for the system, impacts of constraints on the system or system variables, or measurements of output variables. The closed loop system may be used to sense the change and feedback the signal to the process input. In biofuel systems, closed loop systems may predominate, since these systems may be regulated subject to constraints such as production (product) quality, energy costs, process unit capacity, etc.

Control System—the regulatory level mechanism by which the manipulated variables are driven to the set points.

Response—the measurement of the current position of the manipulated variable. The response is the feedback of the movement of the manipulated variable to the set point in response to the actions of the control system in its effort to achieve the set point.

Target Profile—a desired profile or trajectory of variable values, i.e., a desired behavior of a control variable or a manipulated variable.

Control Horizon—the period of the time extending from the present into the future during which one plans to move or change manipulated variables. Beyond this horizon the MV is assumed to stay constant at its last or most recent value in the control horizon.

Prediction Horizon—the period of time extending from the present into the future during which the process or system response is monitored and compared to a desired behavior.

### Biofuel Production Process

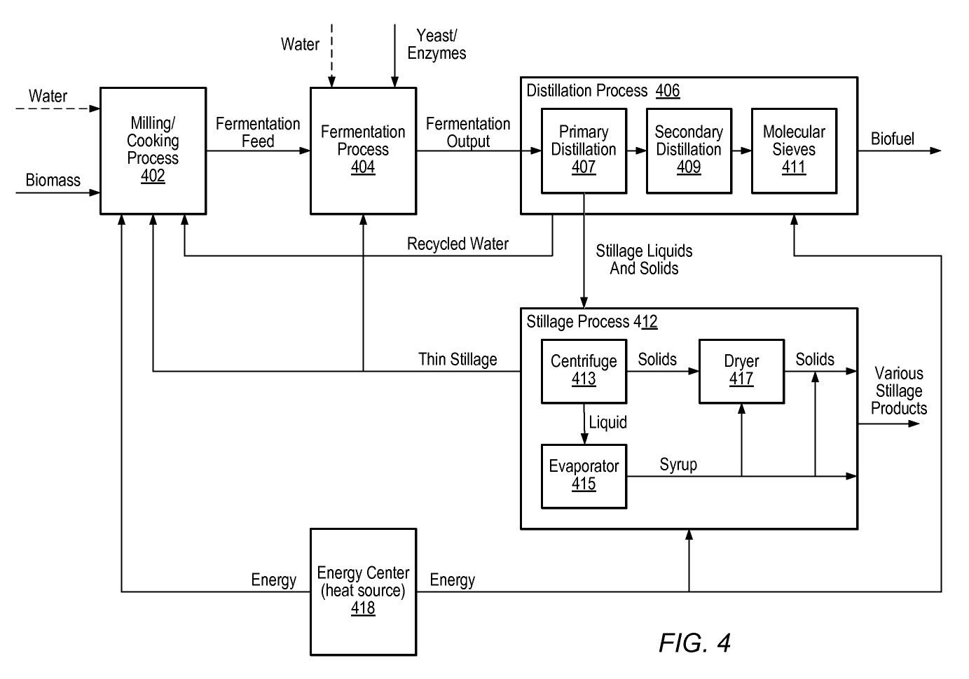

FIG. 4 illustrates an exemplary high-level processing flow schematic of sub-processes of a biofuel production process, according to one embodiment. It should be noted that the particular components and sub-processes shown are meant to be exemplary only, and are not intended to limit embodiments of the invention to any particular set of components or sub-processes.

As FIG. 4 indicates, a milling/cooking sub-process 402 may: receive water, biomass, energy (electrical and/or thermal), recycled water, and/or recycled thin stillage; mill the biomass; cook the mixture; and output a biomass slurry (referred to as a fermentation feed) to a fermentation sub-process 404. The fermentation sub-process 404 may: receive the biomass slurry, water, yeast, enzymes, and recycled thin stillage; ferment the mixture; and output fermentation products to a distillation sub-process 406. The distillation sub-process 406 may: receive the fermentation products, remove water and stillage (liquid and solid stillage) from the fermentation products in a one to three step process (e.g., primary distillation 407, secondary distillation 409, and/or molecular sieves (dryers) 411), recycle water removed from the fermentation products to the milling/cooking sub-process 402, output the liquid and solid stillage to a stillage sub-process 412, and output biofuel products. The stillage sub-process 412 may: receive the liquid and solid stillage, process the liquid and solid stillage (utilizing one or more of centrifuge dryers 413, other dryers 417, and/or evaporators 415) to produce and output various stillage products, and recycle thin stillage liquid to the fermentation sub-process 404 and the milling/cooking sub-process 402. An energy center 418 may provide electric power and heat (steam) to the various sub-processes as shown in FIG. 4.

One or more of the sub-processes described above may be managed and controlled via model predictive control (MPC) utilizing a dynamic multivariate predictive model that may be incorporated as a process model in a dynamic predictive model-based controller. Model predictive control of a sub-process of a biofuel production process is described below, first for a generic sub-process and then in more detail for the stillage sub-process 412, specifically directed to managing the stillage feed provided by the distillation sub-process 406 to the stillage sub-process 412.

### MPC Applied to a Sub-Process of a Biofuel Production Process

Various embodiments of systems and methods for applying model predictive control (MPC) to a biofuel production process are described below. In this approach to biofuel production, a dynamic multivariate predictive model may be incorporated as a process model in a dynamic predictive model-based controller. This MPC system may project or predict what will happen in the production process (e.g., in the near future) based on the dynamic prediction model and recent process history, including, for example, recent operating conditions or state values. This projection or prediction may be updated or biased based on received current process information, specified objectives, and/or system or method constraints. Control algorithms may be used to recursively or iteratively estimate the best current and future control adjustments on the model inputs to achieve a desired output path. Targets set on the dynamic model outputs may be compared to how that output may behave over a predictive future horizon and the best available controllable model input adjustments may be estimated to best achieve the controller targets.

It should be noted that the biofuel or biofuels produced by embodiments of the methods described herein may be any biofuel generated from biomass, and that the types of biomass contemplated may be of any type desired, including, but not limited to, grains (e.g., corn, wheat, rye, rice, etc.), vegetables (e.g., potatoes, beats, etc.), canes (e.g., sugarcane, sorghum, etc.), and other recently living organisms and/or their bi-products.

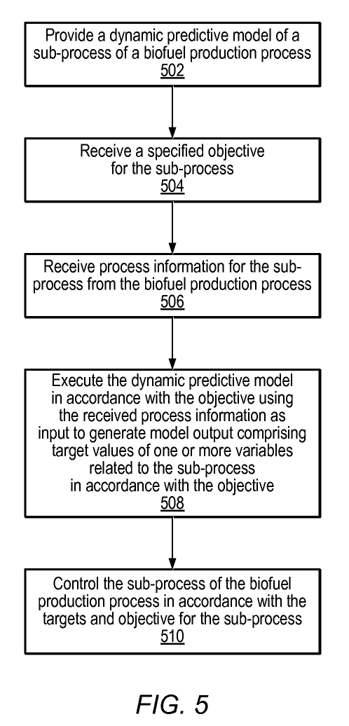

FIG. 5 is a high-level flowchart of a computer-implemented method for managing a sub-process of a biofuel production process utilizing model predictive control (MPC), according to one embodiment. As used herein, the term biofuel refers to one or more biofuel products output from a biofuel production process. It should be noted that embodiments of the method of FIG. 5 may be used with respect to any sub-process of a biofuel production process desired (e.g., milling/cooking, fermentation, distillation, and/or stillage sub-processes), as well as combinations of such sub-processes. In various embodiments, some of the method elements shown may be performed concurrently, in a different order than shown, or may be omitted. Additional method elements may also be performed as desired. As shown, this method may operate as follows.

In 502, a dynamic multivariate predictive model (also referred to as a dynamic predictive model) of a sub-process of a biofuel production process may be provided. In other words, a model may be provided that specifies or represents relationships between attributes or variables related to the sub-process, including relationships between inputs to the sub-process and resulting outputs of the sub-process. Note that the model variables may also include aspects or attributes of other sub-processes that have bearing on or that influence operations of the sub-process.

The model may be of any of a variety of types. For example, the model may be linear or nonlinear, although for most complex processes, a nonlinear model may be preferred. Other model types contemplated include fundamental or analytical models (i.e., functional physics-based models), empirical models (such as neural networks or support vector machines), rule-based models, statistical models, standard MPC models (i.e., fitted models generated by functional fit of data), or hybrid models using any combination of the above models.

In 504, an objective for the sub-process may be received. The objective may specify a desired outcome, result, behavior, or state, of the sub-process, such as, for example, a desired throughput, quality, efficiency, product profile, behavior, or cost, among others. In preferred embodiments, the objective may specify at least one targeted measurable attribute defining product quality for the sub-process (or the overall production process). Note that an objective may be a specific value, such as a specified percent solids for a fermentation feed, a specified temperature of a fermentation vat, etc., or may be a specified extremum, i.e., a maximum or minimum of an attribute, such as, for example, minimizing cost, maximizing production, etc.

It should be noted that as used herein, the terms “maximum”, “minimum”, and “optimum”, may refer respectively to “substantially maximum”, “substantially minimum”, and “substantially optimum”, where “substantially” indicates a value that is within some acceptable tolerance of the theoretical extremum, optimum, or target value. For example, in one embodiment, “substantially” may indicate a value within 10% of the theoretical value. In another embodiment, “substantially” may indicate a value within 5% of the theoretical value. In a further embodiment, “substantially” may indicate a value within 2% of the theoretical value. In yet another embodiment, “substantially” may indicate a value within 1% of the theoretical value. In other words, in all actual cases (non-theoretical), there are physical limitations of the final and intermediate control element, dynamic limitations to the acceptable time frequency for stable control, or fundamental limitations based on currently understood chemical and physical relationships. Within these limitations the control system will generally attempt to achieve optimum operation, i.e., operate at a targeted value or constraint (max or min) as closely as possible.

Moreover, in some embodiments, an objective may include multiple components, i.e., may actually comprise a plurality of objectives and sub-objectives. In some embodiments, the objective may involve multiple variables, e.g., a ratio of variables. Moreover, in some embodiments, there may be a global objective, e.g., maximize production or profit, and multiple sub-objectives that may in some cases be at odds with the global objective and/or one another.

In 506, process information for the sub-process of the biofuel production process may be received. In other words, information related to the sub-process may be received, e.g., from the sub-process (or from other portions of the biofuel production process that influence the sub-process), and/or from other sources, e.g., a laboratory, inferred property models (that model variables that are not readily measurable), external systems, or any other source as desired. This information generally includes data from one or more sensors monitoring conditions of and in the sub-process (e.g., temperatures, pressures, flow rates, equipment settings, and so forth), although any other information germane to the sub-process may be included as desired (e.g., constraints to which the sub-process may be subject, ambient conditions of the biofuel process, economic or market data, and so forth).

In 508, the model may be executed in accordance with the objective for the sub-process using the received process information as input, to generate model output comprising target values for one or more manipulated variables related to the sub-process in accordance with the objective for the sub-process. In other words, the model may be executed with the received process information as input, and may determine target values of one or more controllable attributes of the sub-process in an attempt to meet the specified objective for the sub-process (which could be a global objective for the entire biofuel production process). For example, in an embodiment where the objective is to maximize output for the sub-process, the model may determine various target values (e.g., sub-process material input flows, temperatures, pressures, and so forth) that may operate to maximize the output. As another example, in an embodiment where the objective is to minimize waste for the sub-process, the model may determine target values that may operate to minimize waste for the sub-process, possibly at the expense of total output. In a further example, the objective may be to maximize profit for the entire production process, where maximizing output and minimizing waste may be two, possibly competing, sub-objectives, e.g., included in the objective.

In some embodiments, the execution of the model in 508 may include executing the model in an iterative manner, e.g., via an optimizer, e.g., a nonlinear optimizer, varying manipulated variable values (which are a subset of the model inputs) and assessing the resulting model outputs and objective function, to determine values of the manipulated variables that satisfy the objective subject to one or more constraints, e.g., that optimize the sub-process subject to the constraints, thereby determining the target values for the manipulated variables.

In 510, the sub-process of the biofuel production process may be controlled in accordance with the corresponding targets and objective for the sub-process. Said another way, a controller coupled to the dynamic multivariate predictive model may automatically control various (controllable) aspects or variables of the sub-process according to the target values output by the predictive model to attempt to achieve the specified objective.

The method of FIG. 5 may be repeated, e.g., at a specified frequency, or in response to specified events, so that the process may be monitored and controlled throughout a production process, or throughout a series of production processes. In some embodiments, the period or frequency may be programmed or varied during the production process (e.g., an initial portion of a production process may have longer repetition periods (lower frequency), and a critical portion of a production process may have shorter repetition periods (higher frequency)).

In some embodiments, a system implementing the control techniques disclosed herein may include a computer system with one or more processors, and may include or be coupled to at least one memory medium (which may include a plurality of memory media), where the memory medium stores program instructions according to embodiments of the present invention. In various embodiments, the controller(s) discussed herein may be implemented on a single computer system communicatively coupled to the biofuel plant, or may be distributed across two or more computer systems, e.g., that may be situated at more than one location. In this embodiment, the multiple computer systems comprising the controller(s) may be connected via a bus or communication network.

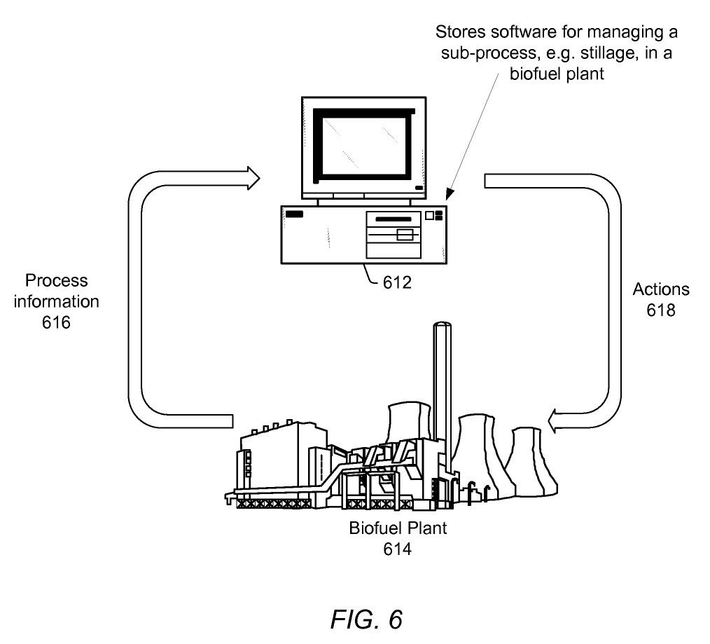

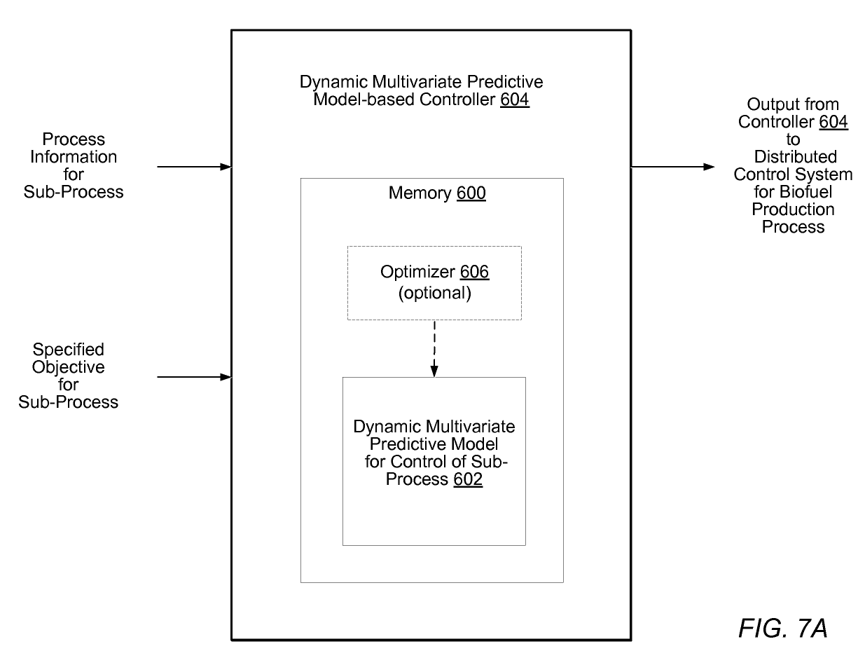

FIG. 6 illustrates a simplified view of an automated control system for a biofuel production plant 614. As shown, the system may include one or more computer systems 612 which interact with the biofuel plant 614 being controlled. The computer system 612 may represent any of various types of computer systems or networks of computer systems which execute software program(s) according to various embodiments of the invention. As indicated, the computer system stores (and executes) software for managing a sub-process, e.g., stillage, in the biofuel plant 614. The software program(s) may perform various aspects of modeling, prediction, optimization and/or control of the sub-process. Thus, the automated control system may implement predictive model control of the sub-process in the biofuel plant or process. The system may further provide an environment for making optimal decisions using an optimization solver, i.e., an optimizer, and carrying out those decisions, e.g., to control the plant.

One or more software programs that perform modeling, prediction, optimization and/or control of the plant 614 (particularly, the sub-process, e.g., stillage process) may be included in the computer system 612. Thus, the system may provide an environment for a scheduling process of programmatically retrieving process information 616 relevant to the sub-process of the plant, and generating actions 618, e.g., control actions, to control the sub-process, and possibly other processes and aspects of the biofuel plant or process.

The one or more computer systems 612 preferably include a memory medium on which computer programs according to the present invention are stored. The term “memory medium” is intended to include various types of memory or storage, including an installation medium, e.g., a CD-ROM, or floppy disks, a computer system memory or random access memory such as DRAM, SRAM, EDO RAM, Rambus RAM, etc., or a non-volatile memory such as a magnetic medium, e.g., a hard drive, or optical storage. The memory medium may comprise other types of memory as well, or combinations thereof. In addition, the memory medium may be located in a first computer in which the programs are executed, or may be located in a second different computer which connects to the first computer over a network. In the latter instance, the second computer provides the program instructions to the first computer for execution.

Also, the computer system(s) 612 may take various forms, including a personal computer system, mainframe computer system, workstation, network appliance, Internet appliance or other device. In general, the term “computer system” can be broadly defined to encompass any device (or collection of devices) having a processor (or processors) which executes instructions from a memory medium.

The memory medium (which may include a plurality of memory media) preferably stores one or more software programs for performing various aspects of model predictive control and optimization. The software program(s) are preferably implemented using component-based techniques and/or object-oriented techniques. For example, the software program may be implemented using ActiveX controls, C++ objects, Java objects, Microsoft Foundation Classes (MFC), or other technologies or methodologies, as desired. A CPU, such as the host CPU, executing code and data from the memory medium comprises a means for creating and executing the software program according to the methods or flowcharts described below. In some embodiments, the one or more computer systems may implement one or more controllers, as noted above.

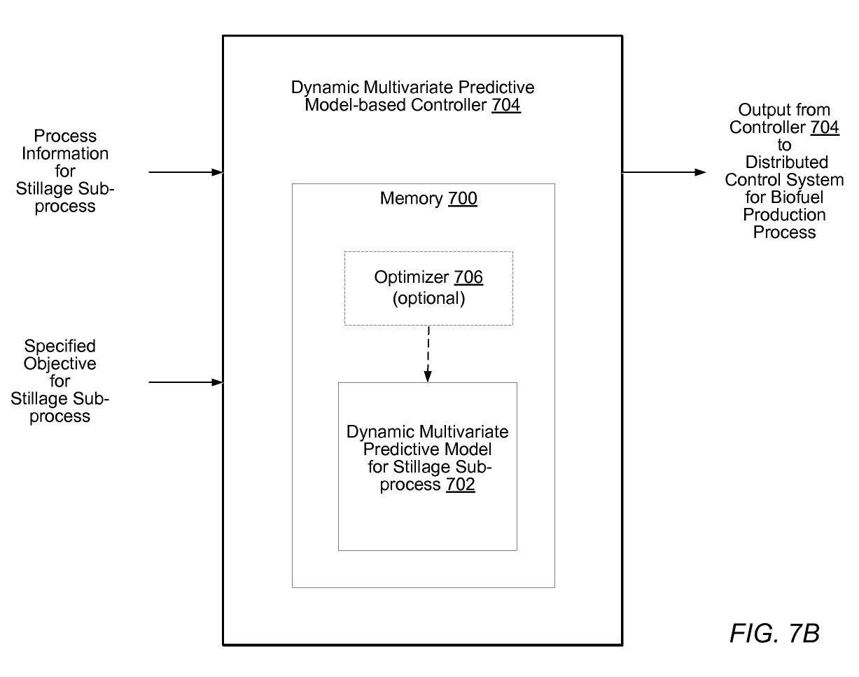

FIG. 7A illustrates an exemplary system for managing a sub-process of a biofuel production process, which may implement embodiments of the method of FIG. 5. The system may comprise: 1) a dynamic multivariate predictive model 602 (e.g., a predictive control model of a sub-process in the biofuel production process) stored in a memory medium 600; and 2) a dynamic predictive model-based controller 604 coupled to the memory medium 600.

As described above in more detail with respect to FIG. 5, the controller 604 may be operable to: receive an objective for a sub-process, receive process information related to the sub-process from the biofuel production process (possibly including information from a laboratory and/or inferred property models), execute the model in accordance with the objective for the sub-process using the received corresponding process information as input, to generate model output comprising target values for one or more variables related to the sub-process in accordance with the objective for the sub-process. In addition, as described above with respect to FIG. 5 in more detail, the dynamic predictive model-based controller 604 may control the sub-process of the biofuel production process in accordance with the corresponding targets and objective for the sub-process.

In one embodiment, the controller 604 may output the target values to a distributed control system (not shown in FIG. 7A) for the biofuel production plant. In some embodiments, the target values may include or be one or more trajectories of values over a time horizon, e.g., over a prediction or control horizon. Process information may include measurements of a plurality of process variables for the sub-process and other inter-related sub-processes, information on one or more constraints, and/or information about one or more disturbance variables related to the sub-process. Process information may be received from the distributed control system for the biofuel plant, entered by an operator, or provided by a program. For example, in addition to values read (by sensors) from the actual process, the process information may include laboratory results, and output from inferred property models, e.g., virtual online analyzers (VOAs), among other information sources.

In some embodiments, the memory medium 600 may be part of the controller 604. In other embodiments, the memory medium 600 may be separated from the controller 604 and connected via a bus or a communication network. In one embodiment, the memory medium 600 may include a plurality of memory media, with different portions of the model 602 stored in two or more of the memory media, e.g., via a storage area network, or other distributed system.

The following describes more specific embodiments of model predictive control of a sub-process of a biofuel production process according to the method of FIG. 5 and system of FIGS. 6 and 7A. Note, however, that the embodiments of the particular sub-process described are meant to be exemplary, and that such model predictive control may be applied to other embodiments of the described sub-process of the biofuel production process as desired.

### MPC Control of a Stillage Sub-Process in a Biofuel Production Process

An overview of the stillage sub-process is presented, and then model predictive control as applied to the stillage sub-process or portions thereof is described.

### Stillage Separation and Evaporation and/or Drying Processes

As discussed above and illustrated in FIG. 4, equipment for processing stillage may include one or more centrifuges 413, one or more evaporators 415, and zero, one, or more dryers 417. The one or more centrifuges 413 may receive a stillage feed (a mixture of liquid and solid stillage) from the bottom outputs of the primary distillation towers 407. The stillage feed from the primary distillation units 407 may be routed to inventory tanks (not shown in FIG. 4), which may be used as surge reservoirs to regulate the stillage feed flow rates between the distillation units 407 and the centrifuges 413. The one or more centrifuges 413 may separate liquids from the stillage feed, output the liquids (also referred to as centrate or thin-stillage), and output the remaining solids (dewatered stillage, also referred to as wet cake). The solids (including moisture and non-fermentable solids) may be sent to the dryers 417. Part of the liquids (thin-stillage) may be recycled back to the fermentation sub-process 404 and/or the milling/cooking sub-process 402 and the balance of the liquids may be sent to the one or more evaporators 415 to evaporate moisture from the liquids to form a concentrated syrup. The syrup may be sent to a syrup inventory unit (not shown in FIG. 4) before being combined with the dewatered stillage in the dryers 417, combined with the dried stillage output from the dryers 417, and/or sold as a stand-alone product. The stillage sub-process equipment may also include various heaters (not shown in FIG. 4) and combustors (not shown in FIG. 4) for the destruction of volatile organic compounds in the vapors from the drying stillage in the one or more evaporators 415 or dryers 417, and the necessary energy supply facilities 418.

Below are described various systems and methods for using model predictive control to improve the yield, throughput, and/or energy efficiency of the stillage sub-process, in accordance with specified objectives. These objectives may be set and various portions of the process controlled continuously to provide real-time control of the production process. The control actions may be subject to or limited by plant and/or external constraints.

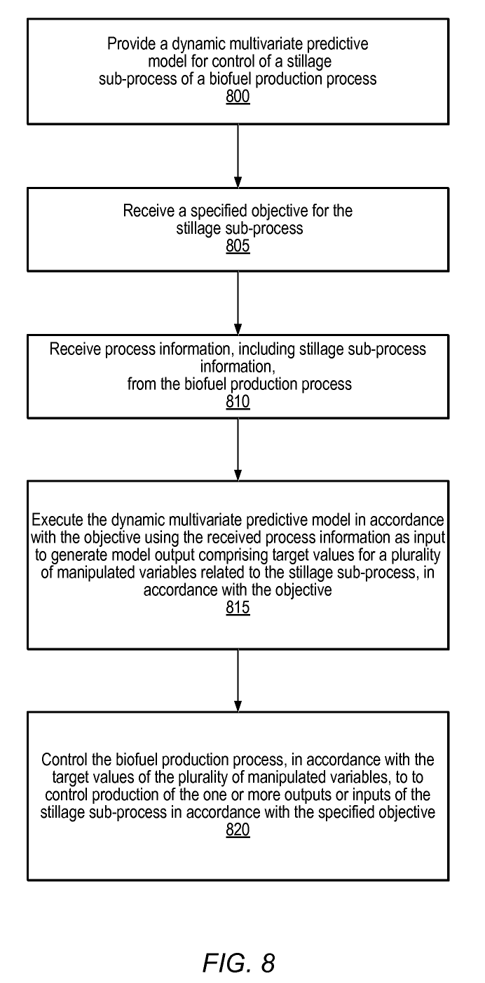

FIGS. 7B and 8 are directed to model predictive control of a stillage sub-process in a biofuel production process (e.g., the stillage sub-process 412 in FIG. 4). More specifically, FIG. 7B is a high-level block diagram of one embodiment of a system for management of the stillage sub-process utilizing model predictive control to manage stillage output product quality and other objectives of the stillage sub-process in a biofuel production process. FIG. 8 is a high-level flowchart of one embodiment of a method for management of the stillage sub-process utilizing model predictive control, where the stillage sub-process provides one or more stillage output products for a biofuel production process.

In some embodiments, the stillage sub-process described below includes a stillage separation process and a stillage drying process utilizing one or more stillage processing units and one or more stillage drying units, and evaporator units for concentrating liquids separated from the stillage. First, an overview of the stillage separation and stillage drying processes is presented, and then model predictive control as applied to the stillage separation and stillage drying processes or portions thereof is described. An MPC operating objective for the stillage separation and stillage drying processes may include operation of the stillage processing units and stillage dryer units at an optimum targeted stillage feed rate, economically, i.e., to an economic control objective, and within constraints, such as product quality constraints, process constraints, and/or environmental constraints, among others. Economic objective with respect to stillage processing may relate to the variable drying costs related to the variable product values on wet and dry distillers grains—an economic objective may use updated costs/value to determine what amounts of dried or wet distillers grains to produce.

Any of the operations and controllable variables of the above described stillage sub-process may be managed or controlled using model predictive control techniques. Below are described various exemplary systems and methods for doing so, although it should be noted that the particular operations and variables discussed are meant to be exemplary, and that any other aspects of the stillage sub-process may also be managed using model predictive control as desired.

### FIG. 7B—System for MPC Control of Stillage Sub-Process

As shown in FIG. 7B, in one embodiment, a system for management of a stillage sub-process of a biofuel production process may include: a dynamic multivariate predictive model of the stillage sub-process 702 stored in a memory medium 700, and a dynamic predictive model-based controller 704 (also referred to as a dynamic multivariate predictive model-based controller) coupled to the memory medium 700. In one embodiment, the controller 704 may be or include a computer system with one or more processors. In one embodiment, the controller 704 may be distributed across two or more computer systems situated at more than one location of the biofuel plant, and in this embodiment, the multiple computer systems comprising the controller 704 may be connected via a bus or communication network. In some embodiments, the memory medium 700 may be part of the controller 704. In other embodiments, the memory medium 700 may be separated from the controller 704 and connected via a bus or a communication network. In one embodiment, the memory medium 700 may include a plurality of memory media, with different portions of the model 702 stored in two or more of the memory media.

The dynamic multivariate predictive model-based controller 704 may be executable to: receive process information related to the stillage sub-process from the biofuel production process (possibly including information from a laboratory and/or inferred property models), receive a specified objective for the stillage sub-process, e.g., at least one targeted measurable attribute defining product quality for one or more stillage sub-process output products, and execute the dynamic multivariate predictive model, to generate model output comprising target values (possibly trajectories, e.g., over a time horizon) for one or more manipulated variables related to the stillage sub-process in accordance with the specified objective. The controller 704 may be operable to control the stillage sub-process in accordance with the target values and the specified objective. In some embodiments, the dynamic multivariate predictive model 702 may include a plurality of sub-models directed to or modeling different portions of the stillage sub-process. In one embodiment, the controller 704 may output the target values to a distributed control system (not shown in FIG. 7B) for the biofuel production plant. Process information may include measurements (and/or derived or inferred values) of a plurality of process variables for the sub-process and other inter-related sub-processes, information on one or more constraints, and/or information about one or more disturbance variables related to the sub-process. Process information may be received from the distributed control system for the biofuel plant, entered by an operator, or provided by a program. For example, as noted above, in addition to values read (by sensors) from the actual process, the process information may include laboratory results, and output from inferred property models, e.g., virtual online analyzers (VOAs) or “approximators”, among other information sources.

Thus, in one embodiment, the dynamic predictive model-based controller may include property inferential models (VOAs), that may calculate inferred quality properties from one or more inputs of measured properties such as temperatures, flows, and pressures. One inferential model, for example, may compute the real-time property of % moisture (or % solids) of the stillage product and/or the real-time property of % moisture (or % solids) of the syrup product.

In one embodiment, the process of providing energy to the centrifuges 413, evaporators 415, and/or dryers 417 may be represented in the dynamic multivariate predictive model 702 of the stillage sub-process. In this embodiment, the dynamic predictive model-based controller 704 may also be executable to measure and regulate the heat energy supplied to the centrifuges 413, evaporators 415, and/or dryers 417.

As noted above, the dynamic multivariate predictive model 702 may be incorporated as a process model in the dynamic predictive model-based controller 704, and may be executed to provide target values for manipulated variables. In one embodiment, an optimizer program 706 may be stored in the memory medium 700 (shown as an optional element in FIG. 7B). In this embodiment, the controller 704 utilizes the optimizer 706 to execute the dynamic multivariate predictive model in an iterative manner to generate or determine an optimum set of the target values in accordance with the objective for or over a specified time horizon. In this particular case, the optimum set of target values may be calculated by estimating the best, i.e., optimal or near optimal, current and future adjustments to values for the manipulated variables, e.g., over a specified period of time, i.e., a control or prediction horizon.

Model Predictive Control (MPC) may facilitate this best-case (i.e., optimal or near-optimal) achievement of projected future events, and may also enable multivariate balancing, so that, for example, levels across a series of tanks (e.g., fermentation output holding tanks) may be controlled to achieve optimal or near optimal results within process (and/or other, e.g., economic, regulatory, etc.) constraints even with a transient imbalance due to coordination of batch (e.g., fermentation) and continuous (e.g., stillage) operations. An MPC solution may have relative weighting factors to balance trade offs between competing objectives. For example, a tank level may be allowed to swing relatively freely within safe or comfortable operating regions (e.g., a tank level that is not nearly empty or nearing overflow). However, if a tank level forecast estimates that it may be nearly empty or near to over-filling, then different limit weighting may be used to avoid exceeding safe or comfortable operating states.

### FIG. 8—Method for MPC Control of Stillage Sub-Process

Embodiments of a method for management of a stillage sub-process of a biofuel production process are presented below. In one embodiment, as illustrated in FIG. 8, the method may include providing a dynamic multivariate predictive model for control of the stillage sub-process 800; receiving a specified objective for the stillage sub-process 805; receiving process information from the biofuel production process 810; executing the dynamic multivariate predictive model in accordance with the objective using the received process information as input, to generate model output comprising target values for a plurality of manipulated variables related to the stillage sub-process, in accordance with the objective 815; and controlling the biofuel production process, in accordance with the target values for the plurality of manipulated variables to achieve the specified objective 820.

Various embodiments of the method briefly stated above are discussed below in more detail. FIG. 8 is a high-level flowchart of a computer-implemented method for managing a sub-process of a biofuel production process utilizing model predictive control (MPC), according to one embodiment. In various embodiments, some of the method elements shown may be performed concurrently, in a different order than shown, or may be omitted. Additional method elements may also be performed as desired. This method may operate as follows.

### Provide a Model

In 800 of FIG. 8, a dynamic multivariate predictive model of the stillage sub-process of a biofuel production process may be provided. In other words, a model may be provided that specifies or represents relationships between attributes, inputs, and/or other variables of the stillage sub-process as to output product composition (the product outputs of the stillage sub-process or other output products of the biofuel production process). Note that the model variables may also include aspects or attributes of other sub-processes that have bearing on or that influence operations of the stillage sub-process.

The model may be of any of a variety of types. For example, the model may be linear or nonlinear, although for many complex processes, a nonlinear model may be preferred. Other model types contemplated include fundamental or analytical models (i.e., functional physics-based models, also referred to as first-principles models), empirical models (such as neural networks or support vector machines), rule-based models, statistical models, standard MPC models (i.e., fitted models generated by functional fit of data), or hybrid models using any combination of the above models. For example, in some embodiments where a hybrid approach is used, the dynamic multivariate predictive model may include a fundamental model (e.g., a model based on chemical and/or physical equations) plus one or more of: a linear empirical model, a nonlinear empirical model, a neural network, a support vector machine, a statistical model, a rule-based model, or an otherwise empirically fitted model

As is well known to those of skill in the art of model predictive control, a dynamic multivariate predictive model may include a set of process mathematical relationships that includes steady state relationships, and also includes any time lag relationships for each parameter change to be realized. A great variety of dynamic relationships may be possible, and each relationship between variables may characterize or capture how one variable affects another, and also how fast the affects occur or how soon an effect will be observed at another location.

The model may be created from a combination of relationships based on available data such as: vessel volumes and fundamental dynamic and gain relationships, sufficiently available and moving plant historic process data, and supplementary plant testing on variables that cannot be identified from the two previous steps. Models may be customized to the plant layout and design, critical inventories, plant constraints and measurements, and controllers available to manage variables. Moreover, in some embodiments, external factors, such as economic or regulatory factors, may be included or represented in the model. In preferred embodiments, the dynamic multivariate predictive model may be a multivariable predictive control model.

An important characteristic of a dynamic model may be to identify when a control variable will change as a result of a change in one or more manipulated variables. In other words, the model may identify the time-response (e.g., time lag) of one or more attributes of the stillage sub-process with respect to changes in manipulated variables. For example, once a controller adjusts pump speeds there may be a certain time-dependent response before observing an effect at a tank being filled. This time-dependent response may be unique for each independent controller (i.e., flow rates may vary because of differences in system variables (e.g., piping lengths, tank volumes, etc.) between the control actuator and flow sensor and the pump location).

Stillage feed storage tank levels and individual feeds to centrifuges 413 may be managed through calculations of the dynamic model, but there may be other process disturbances that may be unmeasured. For example, consider a situation where a level starts to rise out of balance with filling demand, e.g., because of manual plant changes (e.g., scheduled equipment cleaning that involves draining and/or filling one or more specific tanks)—the dynamic model may be made aware of an imbalance so that corrective actions may be made gradually to avoid dramatic or critical consequences. This may be an issue for many of the tanks that have both batch and continuous plant operations in sequence. Specific tanks may be used to provide storage capacity to facilitate balancing and avoid continuous out-of-control operations after every batch action. Because batch vessels drain rapidly, specific tank levels may be difficult to maintain in automatic level control. Thus, real-time receipt of current vessel and material balance information (flows and levels) may provide an update on current equipment status and the execution of the dynamic model may enable projections to be made to avoid both emptying/over-filling vessels and emergency large flow moves to correct imbalances.

In one embodiment, the dynamic multivariate predictive model may include inferential models (also referred to as property approximators or virtual online analyzers (VOAs)). An inferential model is a computer-based model that calculates inferred quality properties from one or more inputs of other measured properties (e.g., process stream or process unit temperature(s), flow(s), pressure(s), concentration(s), level(s), etc.). In one embodiment, the dynamic multivariate predictive model may be subdivided into different portions, and stored in a plurality of memory media. The memory media may be situated in different locations of the biofuel plant. The controller may communicate with the memory media utilizing a communication system.

In one embodiment, the dynamic multivariate predictive model may receive measurements of one or more variables including, but not limited to, one or more of: stillage feed rates to all and/or each centrifuge 413; flow distribution of stillage between centrifuges 413; recycle backset % to the fermentation sub-process 404; liquid inventories of whole stillage, thin stillage, and/or syrup; evaporator syrup % solids concentration measured by an instrument such as an online density meter or provided by an approximator; heating requirements in the primary distillation columns 407; and/or % moisture concentration of stillage solid product from the dryers 417. The one or more measured variables may include manipulated variables and control variables of the stillage sub-process, and the model generated target values for the one or more variables may include a target value for each of the one or more manipulated variables.

The integrated dynamic multivariate predictive model may also include at least one control variable that is a control variable, which is a function of at least one manipulated variable of the stillage separation process and/or a function of at least one manipulated variable of the stillage evaporation and/or drying process. For example in a stillage processing unit, the primary distillation tower is controlled with a separation index and this variable is a function of distillation feed rate MV and Evaporation steam MV in one type of process design

### Receive a Specified Objective

In 805 of FIG. 8, a specified objective specifying target production for the stillage sub-process may be received. For example, in some embodiments, specifying target production may include specifying one or more of: a target composition, e.g., moisture content, of the output products of the stillage sub-process, a production rate of the output products of the stillage sub-process, or a target feed rate of stillage to the stillage sub-process (i.e., input stillage feed rate of one or more centrifuge units). Note that since stillage (and related products) is composed of moisture and solids, specifying moisture content inherently also specifies solids content, since the two values are complementary, and provide the same information, just in different forms. Thus, for example, specifying 30% moisture automatically specifies 70% solids. Thus, in some embodiments, specifying moisture content may be accomplished by specifying solids content.

In one embodiment, a specified objective for the stillage sub-process may include a desired behavior, attribute, or result of the stillage sub-process (e.g., at least one targeted measurable or model-able attribute defining product quality for the stillage sub-process output). In one embodiment, the dynamic predictive model-based controller may simultaneously control the stillage process and the first stage distillation units in accordance with a specified objective. This objective may be computer generated or input by plant personnel and may involve a variety of process units in a variety of combinations depending on the specific plant and be subject to a variety of process, equipment, safety and environmental constraints. The objective may impact the product yield, throughput, and/or energy efficiency of the stillage processes.

In one embodiment, the specified objective may include one or more of: one or more operator specified objectives; one or more predictive model specified objectives; one or more programmable objectives; a set of target feed rates to the centrifuges 413; one or more cost objectives; one or more product quality objectives; one or more equipment maintenance objectives; one or more equipment repair objectives; one or more equipment replacement objectives; one or more economic objectives; a target throughput for the stillage sub-process; one or more objectives in response to emergency occurrences; one or more dynamic changes in product inventory information; one or more dynamic changes in product quality information; and/or one or more dynamic changes in one or more constraints on the biofuel production process, among others.

In some embodiments, the objective for the stillage sub-process may be specified by a human operator and/or a program. In some embodiments, the objective may include one or more sub-objectives. The sub-objectives may include one or more of: heating load of primary distillation units 407 (also referred to as towers or columns), rate of loss of biofuel into the stillage feed output from the primary distillation units 407, combined stillage feed rate to centrifuges 413, individual feed rates to each centrifuge, flow rate and inventory of non-fermentable solids output, and flow rate and inventory of stillage liquids recycled and output, water content in one or more stillage output products, and purity specification of each stillage output products.

In some embodiments, the specified objective may comprise an objective function. The objective function may specify a set of objective values or relationships corresponding to each of one or more sub-objectives.

In some embodiments, constraint information specifying one or more constraints may also be received. For example, in some embodiments, the objective may include constraint information specifying the one or more constraints, i.e., limitations on various aspects, variables, or conditions, related to the stillage sub-process, although in other embodiments, the constraint information may be separate and distinct from the specified objective. In one embodiment, the constraint information may include dynamic constraint information, e.g., the stillage process may be controlled in accordance with an objective, but may also be subject to dynamic constraints, e.g., constraints on or of the production facility's equipment, product qualities, its raw material costs, material availability, e.g., water constraints, production plans, product value, product market demand, and other constraints. The dynamic multivariate predictive model may be executable to: receive constraint information specifying one or more constraints related to the stillage process, e.g., the stillage separation process and/or the stillage evaporation and/or drying process, as input, and generate model output in accordance with an objective subject to the one or more constraints. The constraint information may include dynamic constraint information. In one embodiment, the one or more constraints may include one or more of: equipment constraints, capacity constraints, temperature constraints, pressure constraints, energy constraints, market constraints, economic constraints, regulatory constraints, operating limits of product markets that affect production rates of products, and/or operator imposed constraints, among others.

In general for integrated stillage processing MPC, constraints may be limitations imposed on stillage flow rate due to the setting of the upper and lower limit of any MV limits, in general. In addition, in some embodiments, the process related CVs can include one or more of: ethanol losses off the bottom of primary distillation unit, the minimum and maximum limits of inventories, (whole stillage, thin stillage and syrup tank level limits); amperage limits of the centrifuges, amperage limits on dryer fans, amperage limits on stillage product transport fans, centrifuge flow balancing objective, and evaporation and/or drying equipment temperature limits, environmental limits for thermal destruction (e.g. minimum temperature limit in a TO), steam pressure limits from HRSG, combustion box pressure limits in dryer heater, and TO heater or dryer pressure limits for safety, among others.

In some embodiments, constraints on the operation of the primary distillation tower units may include one or more of the following constraints: potential of flooding in the primary distillation tower units as measured by delta-P and/or limitation of allowable alcohol loss of the distillation tower bottoms as constrained by fermentation process requirements, economic objectives or stillage handling limitations. Note that tower bottoms alcohol concentration may be measured, inferred as a property or inferred by direct constraints on column temperature drop, pressure compensated temperature or other.

In some embodiments, constraints may include equipment constraints for equipment in the first stage of distillation and/or in the stillage sub-process, including one or more of: operating limits for various pumps, operational status of pumps, stillage feed tank capacities, liquid stillage tank capacities, stillage product inventory tank capacities, operating limits for various control valves, operating limits for valve temperatures, operating limits for pipe pressures, operating temperature limits of equipment, operating limits for proxy measurements of vapor flow from the dryers to the dryer stacks either directly or through thermal oxidizer units, operating limits of all rotary equipment as measured by amperage, temperature, or other load measurement, operating limits of the heating media, operating limits of the stillage feed, and/or safety or environmental limitations for equipment operation. For example, in one embodiment, a constraint on operation of the stillage feed may relate to pumping limitations on any of the various sections of the stillage feed pumps and/or pipes. In situations where an objective is to maximize or maintain stillage output product production rates, or product quality at certain target rates, this objective may drive a pump to its maximum or minimum limit, and the objective may then be compromised due to equipment/pump limits.

In one embodiment, the one or more equipment constraints may also include one or more of: fermentation equipment capacity limits that limit fermentation process output feed rates to the primary distillation units; equipment constraints that limit stillage feed rates or capacity from the primary distillation units; operating limits for one or more pumps in the stillage feed; operational status of pumps (online or offline); stillage tank capacities; tank level limits that limit feed rates to the centrifuges; surge tank levels (maximum or minimum) or pumping limits that limit stillage output flow rates from the primary distillation units; surge tank level or pumping limits that limit feed rates to the evaporators or dryers, operating limits for tank pressures; operational status of tanks; pump speed, valve position, or other controller output limits within the primary distillation or stillage systems; operating limits for valve pressures; operating limits for valve temperatures; equipment amp limits; limits of dryers or evaporators that limit moisture extraction and/or stillage processing capacity flow rates; heating capacity limits that impact heat input to dryers or evaporators; among others.

In one embodiment, the dynamic multivariate predictive model may comprise a multivariate predictive model that represents relationships between the one or more constraints, the objective, including any sub-objectives, and the plurality of manipulated variables.

### Receive Process Information

In 810 of FIG. 8, process information may be received from the biofuel production process. The process information may include measurements of one or more control variables and one or more manipulated variables related to the stillage sub-process and one or more variables of other processes that may impact the stillage sub-process, as well as information from inferential models, laboratory results, etc. The measured variables may include any of: stillage feed rates from distillation units; inventories of stillage in stillage feed holding tanks; limits of stillage feed holding tanks; stillage feed rates to each centrifuge; heat input to the dryers; output flow rate of liquid stillage; output flow rate of solid stillage; the water content of the stillage from each centrifuge; pump speed, valve position, or other controller output within the stillage sub-process; stillage output product composition from one or more dryers; water content of the stillage sub-process products; purity specification of one or more stillage output products; and/or the inventory of one or more stillage output products, among others.

The process information may be communicated to the controller from a distributed control system.

### Execute the Model

In 815 of FIG. 8, the dynamic multivariate predictive model may be executed in accordance with the objective using the received process information as input, to generate model output comprising target values for a plurality of manipulated variables related to the stillage sub-process, in accordance with the objective.

In one embodiment of the invention, the dynamic multivariate predictive model (which may be or include an integrated model of various stillage sub-processes) may be executed by a dynamic predictive model-based controller to generate one or more target values in accordance with a specified objective. The target values may correspond to various manipulated variables including, but not limited to: whole stillage feed rates and inventory; stillage distribution balance through the centrifuges unit(s) (each centrifuge may have a flow controller); thin stillage flow rates and inventories including: thin-stillage recycled back to the fermentation units, and/or thin stillage sent to evaporator units to form a concentrate syrup; % solids in the concentrate syrup; syrup inventories including: syrup combined with partially dried solids in the dryers, syrup added to the solids from the dryers, syrup sold as a stand-alone product; evaporator heating media and draw flow rates; and/or heating requirements in the primary distillation tower units (to prevent loss of product alcohol to the stillage process); and/or % moisture concentration of stillage solid product from the dryer unit(s), among others. The controller may be configured to generate a plurality of target values for manipulated variables simultaneously.

In some embodiments, the specified objective may comprise an objective function. The objective function may specify a set of objective values corresponding to each of one or more sub-objectives. Executing the dynamic multivariate predictive model may further comprise an optimizer executing the dynamic multivariate predictive model in an iterative manner to solve the objective function, where solving the objective function generates the target values for the plurality of manipulated variables in accordance with the objective.

As noted above, in one embodiment, constraint information may be received, e.g., separately, or as part of the objective. In this embodiment, the dynamic multivariate predictive model may be executed in accordance with the objective using the received process information and the one or more constraints as input, to generate model output in accordance with the objective and subject to the one or more constraints.

As also noted above, in one embodiment, the constraint information may be equipment constraints. In this embodiment, executing the dynamic multivariate predictive model may comprise executing the dynamic multivariate predictive model using the received process information and received information related to the one or more equipment constraints as input to generate model output in accordance with the objective and subject to the one or more equipment constraints.

As noted above, in some embodiments, the execution of the model may include executing the model in an iterative manner, (e.g., via an optimizer, such as a nonlinear optimizer), varying manipulated variable values and assessing the resulting model outputs and objective function, to determine values of the manipulated variables that optimally satisfy the objective subject to one or more constraints, thereby determining the target values for the manipulated variables.

### Control the Process

In 820 of FIG. 8, the biofuel production process may be controlled in accordance with the target values for the plurality of manipulated variables to achieve the specified objective (subject to any specified constraints).

Below are described various systems and methods for using model predictive control to manage the stillage sub-process and related portions of other sub-processes in accordance with the specified objective. The objective may be set and various portions of the process controlled continuously to provide real-time control of the stillage sub-process. The control actions may be subject to or limited by plant and external constraints. More specifically, in various embodiments of the invention, a dynamic multivariate predictive model (or models) and controller(s) may be utilized to control one or more aspects of the stillage sub-process and related portions of other sub-processes, including, but not limited to, one or more of: (1) feed rate to the primary distillation tower units, (2) heating requirements in the primary distillation tower units, (3) feed rate of stillage from the primary distillation tower units to the stillage centrifuge units, (4) distribution of stillage flow through each of the centrifuge units for separation of liquids from non-fermentable solids, (5) feed rate of thin stillage to the fermentation process (also referred to as recycle backset % or backset recycle streams), (6) energy to a syrup evaporator, (7) feed rates of syrup to each dryer and to the product from the dryers, (8) flow rate of syrup as a separate product from an evaporator, (9) control variables (CVs), and/or (10) combustion and/or process heating energy demand of the stillage sub-process.

In one embodiment, controlling flow rates of stillage to stillage centrifuge units by the dynamic predictive model-based controller may involve one or more of: one or more flow controllers coupled to feed rate of the primary distillation units, and/or feed rate to each of the stillage processing units.

In one embodiment, controlling the balance of the whole stillage distribution by the predictive model-based controller may involve one or more of: measures of flow rates to each centrifuge; a stillage distribution objective flow rate for each centrifuge, operator or programmable entry of the flow distribution objectives, and/or operational status of each centrifuge.

In one embodiment, the model predictive control of whole stillage inventory may involve one or more of: a measure of whole stillage inventory, operator or computer entered whole stillage control objectives, targeted stillage feed rates, primary distillation unit feed rates, and/or centrifuge feed rates.

In one embodiment, controlling the stillage sub-process may include controlling the flow rates of the stillage feed, which may include operating the stillage feed flow controllers coupled to the dynamic model, and/or operating the stillage feed flow controllers coupled to the biofuel production rate target. For example, stillage feed flow may be adjusted to manage throughput to a target production rate for the stillage sub-process output and/or the stillage feed may be restricted to flow rates within which acceptable output product quality can be achieved.

In one embodiment, controlling the stillage sub-process may include controlling the primary distillation tower heat balance, which may include or utilize one or more of: a direct measurement of the primary distillation tower heat load, a proxy measurement of temperature such as a measurement of delta T (change in temperature) in the primary distillation tower, an operator or computer entered heat load control objective, a computer calculation of adjustments to the distillation feed rate, and/or a computer calculation of adjustments to heating rate or heat content.

In one embodiment, controlling the stillage sub-process may include model predictive control of the loss of biofuel into stillage, which may include or utilize one or more of: a measure of loss of biofuel in stillage by a measurement via an instrument or by an inferential model, operator or computer entered biofuel in a stillage concentration control objective, computer calculation and adjustments of distillation feed rate, and/or computer calculation and adjustments of heating rate or heat content.

In one embodiment, controlling the balance of the whole stillage distribution by the predictive model-based controller may involve one or more of: measures of flow rates to each centrifuge; a stillage distribution objective flow rate for each centrifuge, operator or programmable entry of the flow distribution objectives, and/or operational status of each centrifuge.

In one embodiment, the model predictive control of whole stillage inventory may involve one or more of: a measure of whole stillage inventory, operator or computer entered whole stillage control objectives, targeted stillage feed rates, primary distillation unit feed rates, and/or centrifuge feed rates.

In one embodiment, the model predictive control of thin stillage inventory may involve one or more of: a measure of thin stillage inventory, operator or computer entered thin stillage control objectives, targeted stillage feed rates, primary distillation feed rate, backset flow rates directly to fermentation units or to the fermentation feed, centrifuge feed rates, heating media rates or heat duty to the evaporator units, and/or evaporator syrup draw rates.

In one embodiment, the model predictive control of the % solids concentration in the output from the evaporators may involve one or more of the following: a measure of syrup concentration (% solids) (measured by instrument or calculated by an inferential process model) and flow rate, evaporator heating media flow rate or duty, and/or an operator or computer entered syrup concentration control objective.

In one embodiment, the model predictive control of syrup inventory may include one or more of: a measure of syrup inventories and flow rates including flow rates of syrup to the dryer(s), flow rates and routing of syrup to other process units, and/or operator or computer entered syrup control objective.

In one embodiment, the model predictive control of dryer stillage product moisture may involve computer calculation and adjustments of a plurality of variables including one or more of: stillage product moisture off the dryers (in accordance with operator or computer entered stillage product moisture objective), dryer(s) heating media flow rate or duty (implemented with a duty, temperature or flow controller), flow of syrup to the dryer(s), and/or dewatered stillage flow rates to the dryers, which may be inferred or estimated from measurements of centrifuge flow rates

In one embodiment, the system may include an energy center and MPC control may be used to control the energy utilization efficiency for the stillage processing units by regulating the combustion and process heating demand. In another embodiment, the MPC system may be configured to control the energy center subject to environmental requirements. This may be accomplished by controlling: temperatures in the thermal oxidizer for control of destruction of volatile organic compounds (VOCS) from the stillage dryers, damper positions in the thermal oxidizers to adjust the draft pressure in the stacks, and/or natural gas or steam demand of the thermal oxidizer.

In one embodiment, the model predictive control of heating requirements in the primary distillation column and stillage sub-process, may involve one or more of: a proxy measurement of distillation tower separation (such as Delta T or a composition of the light key component of the bottom of the distillation tower), an operator or computer entered distillation column heating control objective, primary column feed rate, stillage feed rate, and/or steam flow rate to the evaporators.

In one embodiment, controlling the biofuel production process may include model predictive control of the inventory of biofuel, which may include or utilize one or more of: a measure of the inventory of one or more biofuel products, an operator or computer entered control objective for the inventory of one or more biofuel products, computer calculation and adjustments of distillation feed rates, computer calculation and adjustments of centrifuge feed rates, computer calculation and adjustments of heating rates or heat duty for the evaporator units, and/or computer calculation and adjustments of evaporator syrup draw rate (e.g., for embodiments where heat recovery from stillage sub-process evaporator operation is integrated with energy consumption within the distillation and/or downstream dehydration operations (e.g., evaporator waste steam vapors are used to drive a column reboiler, or a molecular sieve product condenser is used to reboil a column or provide energy to a stillage evaporator)).

In one embodiment, controlling the stillage sub-process may include model predictive control of the stillage solids moisture content, which may include or utilize one or more of: a computer entered stillage solids moisture quality control objective, a measure of the stillage solids moisture concentration, operator determined stillage solids moisture concentration, use of an inferential model that may compute the real-time property of % moisture (or % solids) of the stillage solids product, and use of an inferential model that may compute the real-time property of % moisture (or % solids) of the syrup product.

As with FIG. 5 above, in preferred embodiments, the method of FIG. 8 may be repeated, e.g., at a specified frequency, or in response to specified events, so that the process may be monitored and controlled throughout a production process, or throughout a series of production processes. In some embodiments, the period or frequency may be programmed or varied during the production process (e.g., an initial portion of a production process may have longer repetition periods (lower frequency), and a critical portion of a production process may have shorter repetition periods (higher frequency)). In some embodiments, the method may be repeated based at least partially on events, e.g., in response to specified conditions.

Thus, in some embodiments, the above receiving an objective, receiving process information, executing the dynamic multivariate predictive model, and controlling the biofuel production process may be repeated with a specified frequency, utilizing updated process information and objectives in each repetition. The frequency may be programmable, and/or operator-determined as desired. In some embodiments, the frequency may be determined by changes in process, equipment, regulatory, and/or economic constraints.

### Additional Embodiments

In one more detailed embodiment, the system and method may provide for integrated management of a first stage distillation process, a stillage separation process and/or a stillage evaporation and/or drying process of a biofuel production process. For example, the system may include: an integrated dynamic multivariate predictive model of two or more of: the first stage distillation, stillage separation, or stillage evaporation and/or drying processes; and a dynamic predictive model-based controller that includes or is coupled to the integrated dynamic multivariate predictive model.

For example, in one embodiment, the dynamic multivariate predictive model represents relationships between a distillation downstream dehydration process and evaporator heat recovery, and the process information includes throughput in the downstream dehydration process, and/or energy use in the downstream dehydration process.

In another embodiment, the dynamic multivariate predictive model represents relationships between energy use of a stillage dryer process and energy input to an thermal oxidizer that oxidizes exhaust from the stillage dryer process, and the process information includes one or more of: dryer energy consumption, or dryer temperature, where the plurality of manipulated variables also includes energy input to the thermal oxidizer.

In another exemplary embodiment, the dynamic multivariate predictive model represents relationships between energy use of centrifuges of the stillage separation process, energy use of a stillage evaporator, and wet distillers grain moisture content and/or syrup moisture content, and the process information includes one or more of: centrifuge energy consumption, centrifuge throughput, evaporator energy consumption, evaporator throughput, or ratio of wetcake and evaporator syrup to wet distillers grain product. The plurality of manipulated variables may further include one or more of: the centrifuge energy consumption, the centrifuge throughput, the evaporator energy consumption, the evaporator throughput, or the ratio of wetcake and evaporator syrup to wet distillers grain product.

The integrated dynamic multivariate predictive model may be executable to: receive first stage distillation process information, stillage separation process information and/or stillage evaporation and/or drying process information from the biofuel production process as input; receive a specified objective for the first stage distillation, stillage separation and/or stillage evaporation and/or drying processes, e.g., at least one targeted measurable attribute defining product quality for the first stage distillation, stillage separation and/or stillage evaporation and/or drying processes; and generate model output comprising target values for one or more variables (i.e., manipulated variables) related to the first stage distillation process, stillage separation process, and/or the stillage evaporation and/or drying process in accordance with the objective. The controller may be operable to control the first stage distillation, stillage separation, and/or stillage evaporation and/or drying processes in accordance with the target values and the specified objective. The dynamic multivariate predictive model may include one or more multivariable dynamic multivariate predictive models, e.g., representing various stillage sub-processes or aspects.

In one embodiment, the plurality of manipulated variables may include one or more of: energy use for the first stage distillation process, stillage separation process, and/or stillage evaporation process, in accordance with the objective, or throughput for the first stage distillation process, stillage separation process, and/or stillage evaporation process, in accordance with the objective.

In one embodiment, a computer-accessible memory medium (which may include a plurality of memory media) stores program instructions for a dynamic multivariate predictive model of a stillage sub-process of the biofuel production process. The program instructions may be executable to perform: receiving an objective specifying at least one measurable attribute defining product quality or composition of an output from the stillage sub-process or other processes of the biofuel production process; receiving process information relating to the stillage sub-process from the biofuel production process; and executing the dynamic multivariate predictive model in accordance with the objective using the process information as input to generate model output comprising target values for a plurality of manipulated variables related to the stillage sub-process in accordance with the objective.

In this embodiment, the program instructions may be further executable to: control the stillage sub-process, in accordance with the target values for the plurality of manipulated variables and the specified objective. More generally, the memory medium may store program instructions implementing embodiments of any of the methods described above.

Thus, various embodiments of the above model predictive control systems and methods may be used to manage a stillage sub-process in a biofuel production process.

Although the embodiments above have been described in considerable detail, other versions are possible. Numerous variations and modifications will become apparent to those skilled in the art once the above disclosure is fully appreciated. It is intended that the following claims be interpreted to embrace all such variations and modifications. Note the section headings used herein are for organizational purposes only and are not meant to limit the description provided herein or the claims attached hereto.

We claim:

1. A computer-implemented method for management of a stillage sub-process of a biofuel production process, comprising:
providing a dynamic multivariate predictive model of the stillage sub-process of the biofuel production process;
receiving an objective for the stillage sub-process specifying target production of one or more outputs of the stillage sub-process, including a target value for one or more of:
dry distillers grain moisture content, wet distillers grain moisture content, or evaporator syrup moisture content;
receiving process information, comprising stillage sub-process information, from the biofuel production process;
executing the dynamic multivariate predictive model in accordance with the objective using the process information as input, to generate model output comprising target values for a plurality of manipulated variables related to the stillage sub-process, in accordance with the objective; and
controlling the biofuel production process, in accordance with the target values of the plurality of manipulated variables, to control production of the one or more outputs or inputs of the stillage sub-process in accordance with the objective.

2. The method of claim 1, wherein said executing the dynamic multivariate predictive model further comprises an optimizer executing the dynamic multivariate predictive model in an iterative manner to generate a substantially optimum set of the target values in accordance with the objective for a specified time horizon.

3. The method of claim 1, wherein the dynamic multivariate predictive model comprises a fundamental model, and one or more of:
a linear empirical model;
a nonlinear empirical model;
a neural network;
a support vector machine;
a statistical model;
a rule-based model; or
an empirically fitted model.

4. The method of claim 1, wherein said specifying target production comprises specifying one or more of:
a target composition for one or more outputs of the stillage sub-process;
a target production rate for one or more outputs of the stillage sub-process; or
a target feed rate of stillage to the stillage sub-process.

5. The method of claim 1,
wherein the objective includes one or more sub-objectives;
wherein the objective comprises an objective function;
wherein the objective function specifies a set of objective values corresponding to each of the one or more sub-objectives.

6. The method of claim 5, wherein each of the objective values is a value type selected from a set of value types comprising: minimum value, maximum value, greater than a specified value, less than a specified value, and equal to a specified value, and wherein the objective function includes a combination of two or more value types.

7. The method of claim 1, further comprising: receiving constraint information specifying one or more constraints, wherein said executing the dynamic multivariate predictive model comprises executing the dynamic multivariate predictive model in accordance with the objective using the received process information and the one or more constraints as input to generate the model output in accordance with the objective and subject to the one or more constraints.

8. The method of claim 7, wherein the one or more constraints comprise one or more of: process constraints, equipment constraints, regulatory constraints, or economic constraints.

9. The method of claim 7, wherein the dynamic multivariate predictive model incorporates relationships between the one or more constraints, the objective, and the plurality of manipulated variables.

10. The method of claim 1, wherein controlling the biofuel production process comprises controlling a stillage feed flow rate, including operating stillage feed flow controllers based on target production of one or more outputs of the stillage sub-process.

11. The method of claim 1, wherein the stillage sub-process comprises two or more of:
a first stage distillation process, a stillage separation process, or a stillage evaporation process of a biofuel production process.

12. The method of claim 11, wherein the plurality of manipulated variables comprises one or more of:
energy use for the first stage distillation process, stillage separation process, and/or stillage evaporation process, in accordance with the objective; or
throughput for the first stage distillation process, stillage separation process, and/or stillage evaporation process, in accordance with the objective.

13. The method of claim 11,
wherein the dynamic multivariate predictive model represents relationships between a distillation downstream dehydration process and evaporator heat recovery; and
wherein the process information comprises one or more of:
throughput in the downstream dehydration process; or
energy use in the downstream dehydration process.

14. The method of claim 11,
wherein the dynamic multivariate predictive model represents relationships between energy use of a stillage dryer process and energy input to an thermal oxidizer that oxidizes exhaust from the stillage dryer process;
wherein the process information comprises one or more of:
dryer energy consumption; or
dryer temperature; and
wherein the plurality of manipulated variables further comprises:
energy input to the thermal oxidizer.

15. The method of claim 11,
wherein the dynamic multivariate predictive model represents relationships between energy use of centrifuges of the stillage separation process, energy use of a stillage evaporator, and wet distillers grain moisture content and/or syrup moisture content;
wherein the process information comprises one or more of:
centrifuge energy consumption;
centrifuge throughput;
evaporator energy consumption;
evaporator throughput; or
ratio of wetcake and evaporator syrup to wet distillers grain product; and
wherein the plurality of manipulated variables further comprises one or more of:
the centrifuge energy consumption;
the centrifuge throughput;
the evaporator energy consumption;
the evaporator throughput; or
the ratio of wetcake and evaporator syrup to wet distillers grain product.

16. The method of claim 1, further comprising:
repeating said receiving an objective, said receiving process information, said executing the dynamic multivariate predictive model, and said controlling the biofuel production process with a specified frequency, utilizing updated process information and objectives in each repetition;
wherein the frequency is one or more of:
programmable; or
operator-determined.

17. The method of claim 16, wherein the frequency is determined by changes in process, equipment, regulatory, and/or economic constraints.

18. The method of claim 1, wherein said receiving the process information comprises receiving information from one or more inferential models of parameters for the stillage sub-process.

19. A system for management of a stillage sub-process of a biofuel production process, comprising:
a dynamic predictive model-based controller comprising:
at least one processor; and
at least one memory medium coupled to the at least one processor, wherein the at least one memory medium stores program instructions implementing a dynamic multivariate predictive model of the stillage sub-process;
wherein one or more of the at least one processor is operable to:
receive an objective for the stillage sub-process specifying target production of one or more outputs of the stillage sub-process specifying a target value for one or more of:
dry distillers grain moisture content, wet distillers grain moisture content, or evaporator syrup moisture content;
receive process information, comprising stillage sub-process information, from the biofuel production process;
execute the dynamic multivariate predictive model in accordance with the objective using the process information as input, to generate model output comprising target values for a plurality of manipulated variables related to the stillage sub-process, in accordance with the objective;
control the biofuel production process, in accordance with the target values of the plurality of manipulated variables, to control production of the one or more outputs or inputs of the stillage sub-process in accordance with the objective.

20. The system of claim 19, further comprising an optimizer program stored in the at least one memory medium, wherein said executing the dynamic multivariate predictive model further comprises the optimizer program executing the dynamic multivariate predictive model in an iterative manner to generate a substantially optimum set of target values for a specified time horizon in accordance with the objective.

21. The system of claim 19, wherein the dynamic multivariate predictive model comprises a fundamental model, and one or more of:
a linear empirical model;
a nonlinear empirical model;
a neural network;
a support vector machine;
a statistical model;
a rule-based model; or
an empirically fitted model.

22. The system of claim 19, wherein said specifying target production comprises specifying one or more of:
a target composition for one or more outputs of the stillage sub-process;
a target production rate for one or more outputs of the stillage sub-process; or
a target feed rate of stillage to the stillage sub-process.

23. A computer-accessible memory medium that stores program instructions for dynamic model predictive control of a stillage sub-process of a biofuel production process, wherein said program instructions are executable to perform:
providing a dynamic multivariate predictive model of the stillage sub-process of the biofuel production process;
receiving an objective for the stillage sub-process specifying target production of one or more outputs of the stillage sub-process specifying a target value for one or more of:
dry distillers grain moisture content, wet distillers grain moisture content, or evaporator syrup moisture content;
receiving process information, comprising stillage sub-process information, from the biofuel production process;
executing the dynamic multivariate predictive model in accordance with the objective using the process information as input, to generate model output comprising target values for a plurality of manipulated variables related to the stillage sub-process, in accordance with the objective; and
controlling the biofuel production process, in accordance with the target values of the plurality of manipulated variables, to control production of the one or more outputs or inputs of the stillage sub-process in accordance with the objective.

24. The memory medium of claim 23, wherein the program instructions further implement an optimizer, wherein the optimizer is executable to perform said executing the dynamic multivariate predictive model in an iterative manner to generate a substantially optimum set of target values for a specified time horizon in accordance with the objective.

25. The memory medium of claim 23, wherein said specifying target production comprises specifying one or more of:
a target composition for one or more outputs of the stillage sub-process;
a target production rate for one or more outputs of the stillage sub-process; or
a target feed rate of stillage to the stillage sub-process.
